(19) United States
(12) Patent Application Publication
(10) Pub. No.: US 2023/0275660 A1
(43) Pub. Date: Aug. 31, 2023

(54) AN OPTICAL WIRELESS COMMUNICATION RECEIVING UNIT, SYSTEM AND METHOD

(71) Applicant: SIGNIFY HOLDING B.V., EINDHOVEN (NL)

(72) Inventors: MATTHIAS WENDT, Würselen (DE); PIETER JOHANNES STOBBELAAR, EINDHOVEN (NL)

(21) Appl. No.: 18/015,045

(22) PCT Filed: Jul. 5, 2021
(86) PCT No.: PCT/EP2021/068453

§ 371 Date: Jan. 6, 2023

(30) Foreign Application Priority Data
Jul. 17, 2020 (EP) 20186448.5

(51) Int. Cl. H04B 10/116; H04B 10/40

(52) U.S. Cl. CPC H04B 10/116; H04B 10/40

(57) ABSTRACT

An Optical Wireless Communication, OWC, system uses a receiving unit having a motion sensor for sensing motion and orientation of the receiving unit. A controller of the system (which may be part of a receiving unit or a transmitting unit or external to both) is configured to derive a prediction of the future orientation and position of the receiving unit, while receiving data from a transmitting unit. From the prediction, a different transmitting unit of the set may be selected for future data transfer and/or a different communication system may be selected for future data transfer.

### FIELD OF THE INVENTION

This invention relates to optical wireless communication receiving units, systems and methods.

### BACKGROUND OF THE INVENTION

LiFi (Light Fidelity) is a new type of Optical Wireless Communication (OWC), which also includes Visible Light Communication (VLC). LiFi, OWC and VLC use light as a media of communication, for replacing cable wire (wireline) communication.

Light based communication offers the ability for high data rate communication, for example up to 14 Gbit/s, for devices having a line of sight between them. This for example applies to a set of communicating devices within an office environment.

International patent application WO2020/101155 A1 discloses a method for supporting vehicle mobility in an outdoor VLC network. According to some techniques, prior to an occurrence of a handover process, a handover pre-notification is provided to a target cell for a vehicle to move shortly thereafter from a current serving cell to the target cell. The pre-notification allows the target cell to prepare for an upcoming handover, including reserving resources for the handover, prior to the occurrence of the handover process.

European patent application EP 3539226 A1 discloses method for directing communication traffic within an application control system, wherein the application control system comprises a plurality of application control components capable of transmitting messages to the communication unit using light waves. By determining position information of the application control components within the application control system and of a communication unit within the application control system, an area of interest for the communication unit is computed based on at least the position information. A subgroup of one or more application control components from the plurality of application control components located within the area of interest of the communication unit is identified and data paths through the application control system are programmed to communicate with the communication unit using the identified subgroup of application control components.

Known LiFi products rely on a grid of optical access points mounted in the ceiling. The beams of these access points are wide enough (and thereby have a large field of view and/or coverage area) to create an overlap with the neighboring access points at the level of the desks beneath. The receiving devices in such a systems are typically located at the desks.

For ease of installation, the grid of access points is for example aligned with the luminaire grid in the ceiling. Each access point in such an installation must reach (illuminate, in case of visible light) several square meters and hence illuminates a significant conical area. Such installations may utilize illumination light for the downlink (towards the dongles and/or mobile devices) and may use infrared light for the uplink (towards the access point) so as not to disturb mobile device users. Alternatively, both downlink and uplink may utilize infrared light thereby at least partially disentangling the lighting and communication infrastructure.

To communicate with the access points, a dongle is connected to a user device such as a laptop or tablet. These dongles also emit a similar broad beam to be sure that at least one access point will receive the signal from the dongle. The beams of the access points and the dongles are fixed in direction, so no adjustment of the beam direction is required.

Each access point comprises a modem connected to one or multiple transceivers. The user devices connect to the access point via an optical link and they also comprise a modem connected to one or multiple transceivers.

The function of the modem is to handle the protocols for transmitting and receiving data over the visible or invisible light connection. The modem transmitter transforms an electrical signal of the transmit data to an optical signal (for example using an LED) and the modem receiver transforms the optical signal to an electrical receive data signal (using a photodiode).

When the receiver is implemented as a mobile device like a mobile phone or a tablet computer it will typically be moved, for example tilted, during use. One of the issues is that exactly when a user wants to interact with the device it will have to handle network interruption which may lead to increased latency.

### SUMMARY OF THE INVENTION

It is an object of the invention to improve on the prior art, this object is achieved by an Optical Wireless Communication, OWC, receiving unit according to claim 1, an OWC system according to claim 7, an OWC method according to claim 9 and a computer program according to claim 11.

According to examples in accordance with an aspect, there is provided an Optical Wireless Communication, OWC, system for transferring data between a transmitting unit and a receiving unit as an optical signal which is propagated over free space,
wherein the system comprises a set of transmitting units, each comprising a light source and a modulating system for modulating data onto a light output,
wherein the receiving unit comprises:
   a motion sensor for sensing motion and orientation of the receiving unit;
   a light detector arranged to detect received light; and
   a demodulating system for demodulating the modulated data,
wherein the system comprises a controller which is configured to derive a prediction of the future orientation and position of the receiving unit, while receiving data from a transmitting unit of the set, and:
   determine from the prediction that a different transmitting unit of the set should be used for future data transfer; and/or
   determine from the prediction that a different communication system should be used for future data transfer.

This system provides a prediction of a future position and orientation to enable the preparations for a handover to be prepared as early as possible, preferably when the communication link is still in place and thereby disrupt the communication during handover for a minimal amount of time.

The prediction may generate a range of positions and range of orientations. The prediction may be used to enable a new channel to be initiated before an existing channel has failed, hence saving time, even for protocols requiring substantial time for handover.

A transmitting unit may search for a receiving unit signal even without being involved in the active connection with the current transmitting unit. If a receiving unit signal can be read, all channel estimations between the receiving unit and the transmitting unit may be performed without giving up the old connection, and no action is required by the receiving unit.

The use of trajectory estimation avoids the need for all transmitting units to constantly monitor all modulated light from the receiving units within their field of view. Thus, this reduces the resources in the transmitting units. The monitoring may instead be restricted to those along a predicted trajectory (or movement or of tilting).

When a transmitting unit does find a significant signal to noise ratio (SNR) in a signal received from a receiving unit, it can signal this SNR to the controller (which functions as a coordinating node). This enables the controller to implement seamless downstream handover.

The upstream handover can also be seamless as the previous transmitting unit and the new transmitting unit have established communication, and a data stream overlap will allow to “make before break”.

The controller may be part of the receiving unit. The receiving unit may then collect various SNR figures and decide if a handover is need. It can use movement sensing and trend analysis for the signal to noise ratio in parallel, to decide whether a change is needed due to a substantial movement or if it was only a spurious movement not to cause a switchover.

The controller may instead be part of a transmitting unit or it may even be distributed between the transmitting units.

The system preferably further comprises a memory which stores a spatial layout of the set of transmitting units, and the controller is configured to take into account the spatial layout in order to determine which different transmitting unit should be used and/or determine that the different communication system should be used.

The controller for example determines whether or not there are any transmitting units suitable for the predicted (range of) positions and orientations taking account of the spatial layout of the system. There may be a set of transmitting units for which preparations for allocating time-slots for the receiving unit are commenced in advance. If there are no suitable transmitting units, preparations may be made to switch to the different communications system, thereby allowing communication to continue in spite of movement.

The memory may be implemented as a separate storage in communication with a system controller or may be implemented as a component of the system controller, this is particularly useful when the prediction is implemented in the system controller. Alternatively, if the prediction is implemented in the controller of the receiving unit, the memory may still be implemented in the system and the relevant information may be transferred to the receiving unit upon configuration, or joining the network (if fixed) or intermittently (if variable), or upon request for storage in a further memory located in the receiving unit.

The motion sensor may comprise a linear acceleration sensor and a turn rate sensor. The linear acceleration sensor for example comprises a 3-axis accelerometer and the turn rate sensor comprises a 3-axis gyroscope.

The controller may be configured to derive the prediction further based on sounds collected by a microphone of the receiving unit. These sounds can provide information relating to receiving unit being picked up.

The controller may be configured to:
provide an instruction for said different transmitting unit of the set to prepare for communication; and/or
provide an instruction for said different communication system to prepare for communication.

This instruction is for example made while communication with one of the transmitting units is still continuing.

The different communication system for example comprises a WiFi system or other RF communication protocol.

The controller may be at least partly implemented at the receiver unit. Alternatively, the controller may comprise a master controller for the system which is remote from the receiving unit, and which is coupled to the set of transmitter units, wherein the receiving unit is configured to provide motion sensing information to the controller via:
a low power RF link; or
optical communication.

Also provided is a receiving unit for an Optical Wireless Communication, OWC, system for transferring data between a transmitting unit, which is one transmitting unit of a set of transmitting units, and the receiving unit as an optical signal which is propagated over free space, comprising:
a motion sensor for sensing motion and orientation of the receiving unit;
a light detector arranged to detect received light;
a demodulating system for demodulating the modulated data; and
a controller which is configured to derive a prediction of the future orientation and position of the receiving unit, while receiving data from a transmitting unit of the set, and:
   determine from the prediction that a different transmitting unit of the set should be used for future data transfer; and/or
   determine from the prediction that a different communication system should be used for future data transfer.

This implementation of the receiving unit incorporates the controller for generating the prediction and optionally the memory.

Also provided is an Optical Wireless Communication, OWC, method for transferring data between a transmitting unit, which is one transmitting unit of a set of transmitting units, and a receiving unit as an optical signal which is propagated over free space, comprising:
transmitting data from the transmitting unit to the receiving unit;
sensing motion and orientation of the receiving unit;
deriving a prediction of the future orientation and position of the receiving unit, while receiving data from the transmitting unit, and:
   determining from the prediction that a different transmitting unit of the set should be used for future data transfer; and/or
   determining from the prediction that a different communication system should be used for future data transfer.

The method may comprise storing a spatial layout of the set of transmitting units, and the method comprises taking into account the spatial layout in order to determine which different transmitting unit should be used and/or determine that the different communication system should be used.

The method may be implemented in software and also provided is a computer program to implement the method.

Although in the above functionality of the transmitting unit(s) and receiving unit(s) were described as at least being a transmitting unit and a receiving unit, it will be clear that the transmitting unit may be implemented using a transceiver unit and the receiving unit may be implemented using a further transceiver unit; thereby allowing bi-directional communication amongst the transceivers without detracting from the invention.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 shows a typical configuration of a LiFi system;

FIG. 2 shows a LiFi system in accordance with the invention;

FIG. 3 is used to explain differences between the uplink and downlink; and

FIG. 4 shows an Optical Wireless Communication, OWC, method.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

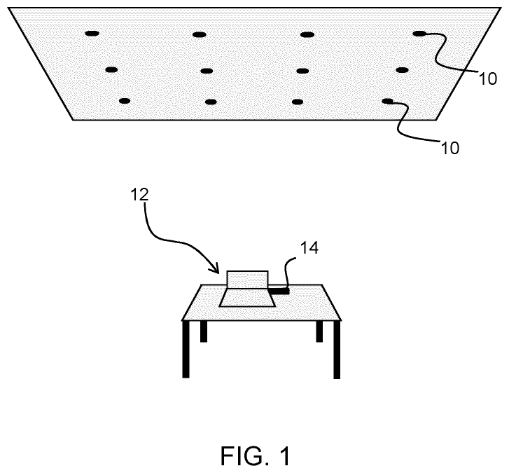

FIG. 1 shows a typical LiFi system with a set of transmitting units 10 forming a ceiling mounted infrastructure and a LiFi receiving unit 12. The transmitting units are known as access points (APs) and are preferably linked to a backbone, e.g. by means of a wired link such as an ethernet link using UTP or an Optical Fiber network allowing the APs and/or a global system controller to align, e.g. on handover. The receiving units are known as end devices (EDs).

Each AP contains a modem connected to one or multiple LiFi transceivers. The end devices can connect to an AP via an optical link. Each ED also contains a modem connected to one or multiple LiFi transceivers. The function of the LiFi-modem is to handle the physical layer (PHY) and media access control layer (MAC) protocols for transmitting and receiving data over the visible or invisible light connection.

The LiFi transceiver comprises a transmitter to transform an electrical signal of the modem's transmit data to an optical signal (e.g. via an LED, a VCSEL or laser diode) and to provide a receiver to transform an optical signal to an electrical of the modem's receive data (e.g. via a photodiode). The end device is for example implemented by a dongle 14 attached to a mobile device such as a laptop. Instead of retro-fitting, it is envisaged that the receiver functionality is ideally integrated with the mobile devices themselves, in this manner laptops, tablets, mobile phones and/or other devices may use optical communication without the need for a dongle. Mobile devices are often placed on office or meeting room tables.

When a mobile device with an integrated or attached LiFi end point, i.e. an end device, is handled it will typically be tilted. One of the issues is that exactly when a user wants to interact with the device it will have to handle network interruption which may lead to increased latency.

During meetings and discussions, users may typically have their mobile devices laying on a table which allows for a stable connection via LiFi. If a user picks up a mobile device it will typically be tilted which means that the up-link beam is directed towards a different spot on the ceiling immediately. The downlink beam may still reach the detector in the mobile device. It depends on the directionality of the detector, e.g. the viewing angle and/or cone of the detector in the mobile device whether or not the downlink still works.

The invention provides an Optical Wireless Communication, OWC, system which uses a receiving unit (i.e. an ED) having a motion sensor for sensing motion and orientation of the receiving unit. A controller of the system (which may be part of a receiving unit or a transmitting unit or external to both) is configured to derive a prediction of the future orientation and position of the receiving unit, while receiving data from a transmitting unit (i.e. an AP). From the prediction, a different transmitting unit of the set may be selected for future data transfer and/or a different communication system may be selected for future data transfer. Which of the options will be used, may depend on the context. For example, consider an office where a regular array of ceiling mounted LiFi APs is provided and a user is located in the middle of the room. In this case, when movement occurs, such will generally result in another LiFi AP being in line of sight. However, when the user is located at an edge of the array, movement may result in a situation where there are no more LiFi APs in line of sight. In such a scenario a vertical handover to a different communication system, such as an RF based system, may be in order.

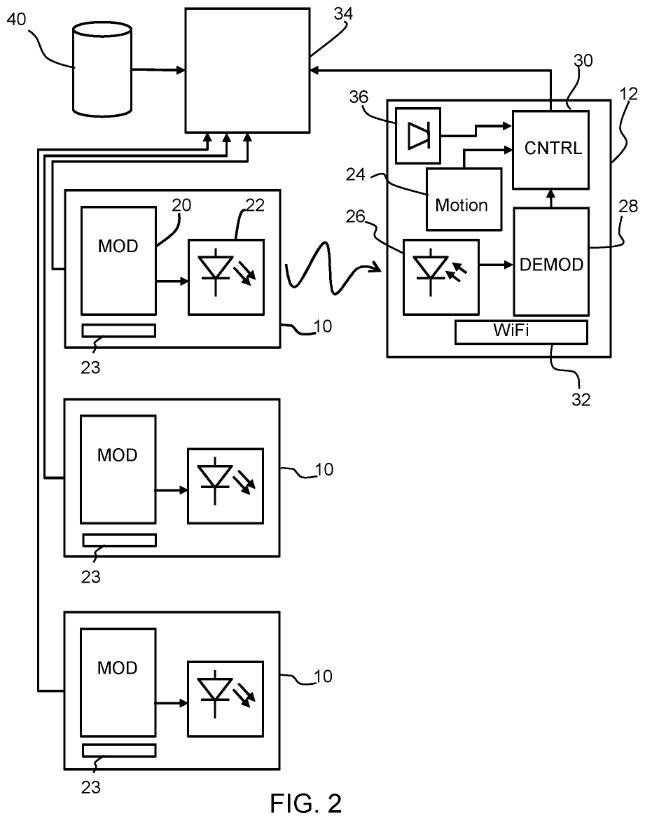

FIG. 2 shows one example of an implementation of the system in accordance with the invention. The system is for transferring data between a transmitting unit 10 and a receiving unit 12 as an optical signal (e.g. in the range of 300 GHz-430 THz infrared) which is propagated over free space.

The system will be described with reference to the downlink, namely the data transfer from a transmitting unit to a receiving unit. However, there will typically be bidirectional data transfer and the system should be understood accordingly. The uplink may also be optical (e.g. infrared) or it may even be an RF connection.

The system comprises a set of the transmitting units 10, each comprising a light source 22 and a modulating system 20 for modulating data onto a light output. Each transmitting unit has a local controller 23.

The receiving unit 12 comprises a motion sensor 24, for sensing the motion and the orientation of the receiving unit. A light detector 26 is arranged to detect received light and a demodulating system 28 is provided for demodulating the modulated data.

The receiving unit also has a local controller 30.

As will be clear from the description above, the transmitting units may also include a light detector and demodulator, and the receiving unit may also include a light source and modulator. However, the up-link may instead be implemented by another communication system such as WiFi. The receiving unit is shown with a WiFi transceiver 32. This may be used for the downlink communication when a LiFi AP is not in view. Other alternative communications systems may also be employed.

The overall system has a system controller 34. It is shown as separate to the receiving unit and the transmitting units, but it may be incorporated in one or other of them. The controller 34 is configured to derive a prediction of the future orientation and position of the receiving unit, while receiving data from a transmitting unit of the set.

A memory 40 stores a spatial layout of the set of transmitting units, and the system controller 34 takes into account the spatial layout in order to determine which different transmitting unit should be used and/or determine that the different communication system should be used.

The memory may be shared with each AP or it may be part of a central unit with which the system controller 34 communicates (as shown). If the EDs are to perform the prediction of future position and orientation as well as the assessment of the APs that will be in view, they may obtain the layout information from the memory and store it locally. As the LiFi infrastructure generally is fixed (in particular for ceiling mounted LiFi APs), such information may be stored upon an ED joining the network. From the prediction, the system controller is able to determine that a different transmitting unit of the set should be used for future data transfer and/or determine from the prediction that a different communication system should be used for future data transfer.

This system thereby provides a prediction of position and orientation to enable the preparations for a handover to be prepared as early as possible, and thereby disrupt the communication during handover for a minimal amount of time.

The prediction for example generates a range of positions and range of orientations. It is used to enable a new channel to be initiated before an existing channel has failed, hence saving time, even for protocols requiring substantial time for take over.

The use of trajectory estimation avoids the need for all transmitting units to constantly monitor all modulated light from the receiving units within their field of view. Thus, the prediction may be used to trigger a sub-set of APs to “sniff” for signals from the ED. This reduces the resources in the transmitting units. For example, power consumption is saved but also demodulators are not tied up which might be needed for another imminent or current connections.

When a transmitting unit (not the current one in use) does find a significant signal to noise ratio (SNR) in a signal received from a receiving unit, it can signal this SNR to the controller, which functions as a coordinating node. The controller may then compare multiple SNRs of potential receiving units and command a connection handover to the best new transmitting unit. The transmitting unit may then already have estimated the channel so it can directly start taking over. This gives the option for seamless downstream handover.

The upstream handover can also be seamless as the previous transmitting unit and the new transmitting unit have established communication, and a data stream overlap will allow to make before break. The previous transmitting unit can stop communication when the new transmitting unit signals successful reception of packets. The receiving unit tunes itself to the new transmitting unit.

The controller may be part of the receiving unit. The receiving unit may then collect various SNR figures and decide if a handover is need. It can use movement sensing and trend analysis for the SNR in parallel, to decide whether a change is needed due to a substantial movement or if it was only a spurious movement not to cause a switch over. This will in addition allow the receiving unit to adaptively learn about directions and locations of transmitting units in order to enhance trajectory estimation without any map of the space. A room map may however be delivered to the receiving unit (as mentioned above) from a first connected transmitting unit connected so that observations of optical streams may allow to adjust the estimated position and direction with a real map.

A transmitting unit may search for the receiving unit signal without being involved in the active connection with the current transmitting unit. If a receiving unit signal can be read, all channel estimations between the receiving unit and the transmitting unit may be performed without giving up the old connection, and no action is required by the receiving unit.

The controller for example determines whether or not there are any transmitting units suitable for the predicted (range of) positions and orientations, taking account of the spatial layout of the system. There may be a set of transmitting units for which preparations for allocating time-slots for the receiving unit are commenced. If there are no suitable transmitting units, preparations may be made to switch to the different communications system.

The motion sensor 24 for example comprises a linear acceleration sensor and a turn rate sensor for movement detection. The linear acceleration sensor for example comprises a 3-axis accelerometer and the turn rate sensor comprises a 3-axis gyroscope. The motion sensor is also for detecting orientation, and may thus include an orientation sensor such as a compass and/or tilt sensor. The term “motion sensor” is used to encompass any combination of sensors for detection of movement and orientation.

The estimation of movement and orientation may use additional assumptions to refine motion sensor information. For example it can be assumed that people will not walk backwards but with the mobile in their hand facing forward. If the ED is on a headset this gives further additional information.

The receiving unit also has a microphone 36 in one example and the sounds are used to assist in deriving a prediction. The sounds can be used to give a clear indication that the ED is being handled, as any noise of handling the device will be picked up by the microphone. The handling of the ED can give a warning prior to detection of tilting and may redirect to an earlier established alternative data connection or AP. The detection of sound may also be used to prioritize or activate the motion sensing and trajectory estimation. This may be used to reduce power consumption as the motion/trajectory estimation could be powered down when no motion/orientation change are detected during a predetermined time (and no noise is detected). The motion/trajectory estimation may then be restarted upon detection of sounds in the audio input from the microphone.

As triggering motion/trajectory estimation based on any sound that exceeds a predetermined threshold may also cause unnecessary power consumption, machine learning might be deployed, to characterize sounds typical for being handled, by means of a learning phase where commonalities/correlation in audio signals prior to a device changing direction/orientation are used to define an audio trigger profile. Then during normal operation audio input corresponding to the audio trigger profile might be used to wake up the motion/trajectory estimation.

An additional optional mode is to provide switching over to an RF based communication when any movement takes place (i.e. a detected turn rate >0) rather than movement along a trajectory for which no new AP is available. A LiFi link may be re-established only when the turn rate is near zero as the device is again placed on the working surface or in a stable operational angle. As soon as rotation or handling of the mobile device is detected, the connectivity system may thereby try to connect to a different network e.g. WiFi, LTE or 5G. This is more efficient than only measuring the signal to noise ratio as communication will be interrupted already before take over actions can be prepared for.

Preferably, instead of switching from LiFi to RF, an RF based communication link may be activated in parallel upon detection of motion at the ED. In this manner information as regards the motion and/or the evaluation by the ED may be communicated to the LiFi APs and/or a system controller for assisting in the handover to a predicted AP even in the absence of a line of sight link to a LiFi AP. In this manner the LiFi link is maintained active as long as possible, but preparations can be made for either a horizontal handover (to another LiFi AP) and/or a vertical handover (to a WiFi AP). The WiFi link in turn can be kept active on a need-to-have basis.

Additional inputs may be used to assist the prediction. For example, handling of the ED may be detected not only based on sound, but also based on an approach of a user's hand either by means of the touch detection electronics or by means of optical sensing means such as a camera.

In order to get best results, the uplink and downlink may be changed over to the next AP location together. The connection may be established for example once the turn rate of the ED is below a threshold (such as 0.1 degrees/second). This ensures that a handover is not made which then needs to be updated straight away.

A memory is mentioned above for storing the AP configurations. However, in order to relate the orientation to the positions of APs in a room, a self-learning approach may alternatively, or additionally, be used. A magnetic compass may also be employed. An estimated final angle may be used which can be determined by observing the rotational speed profile which may be processed to determined where a movement might stop.

The handover is preferably started before the current LiFi link is disrupted as mentioned above. Accelerometers can sense tendency of movement even before the actual angular turn has been made. The APs in the predicted trajectory can thereby search for the beam of the mobile device already. This can considerably speed up reconnection.

The downlink can be kept during searching as the angle change does not have the same drastic influence as for the uplink beam and may only jump when the uplink connection has been made already.

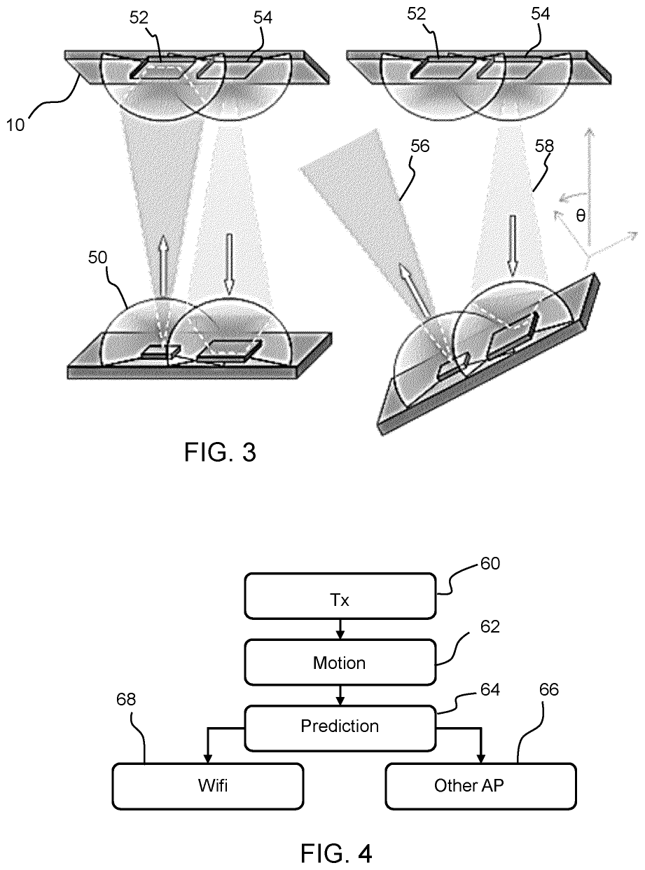

FIG. 3 shows how this asymmetry between the uplink and the down link derives from the fact that the reception for downlink is possible over a wide angle range for most LiFi receivers whereas the uplink transmission uses a narrower beam in order to focus the transmission energy to one access point as far as possible.

FIG. 3 shows that the ED optics 50 are directed towards the access point 10 where there is a photodetector 52 and IR emitter 54. The ED optics are shown tilted by an angle θ in the right image. This causes the emitted beam 56 no longer to reach the photodetector 52. The tilted ED is still able to receive the beam 58 coming from the AP.

The handover sequence is for example programmed. From the current AP, a sequence of APs may be evaluated along the current rotational direction. The rotational speed may give indications which AP will probably come into sight at which moment. An evaluation may be performed to find out that the path cannot be supported seamlessly by LiFi APs and thus an alternative communication link like WiFi needs to be established.

Changes in rotational direction and speed can be used to iteratively refine the trajectory of the LiFi beam in space.

The system will also need to switch back to LiFi if the alternative communication system has been used. The starting point is then an RF based connection (for example WiFi, LTE or 5G) of the mobile ED. The mobile device is then tilted as discussed above. Information is then gained form the motion and orientation sensors. Once the ED is placed on a desk, the motion information will be stable. After reaching a stable level the connection is switched back to LiFi.

For completeness a typical connection process will now be described based on the ITU-T home networking G.vlc protocol (G.9991). When a receiving unit (ED) enters the coverage area of a transmitting unit (AP), the following steps are taken:

### 1. Registration

The ED detects a dedicated frame sent by the AP: MAP-D (Default Medium Access Plan). The time for detecting the MAP-D frame depends how often an AP sends it. In the currently proposed LiFi implementation, the AP sends the frame every MAC-cycle (40 ms).

With the information retrieved from the frame MAP-D, the ED should be able to decode another non-default frame: MAP-A. An AP must send a MAP-A frame every MAC-cycle. The MAP-A frame tells where to find other frames in the MAC-cycle.

With the information retrieved from the frame MAP-A, the EP can register to the AP via a RCBTS (Registration Contention Based Time Slot) in the MAC-cycle. The RCBTS is indicated in the frame MAP-A. The AP has to respond within 200 ms.

The total amount of time for registration is typically within 350 ms.

### 2. Channel Estimation

In general the receiver is mostly in control. It measures test signals and determines a BAT (Bit Allocation Table). Multiple BATs can be determined, each applying to a part/region of the MAC cycle. The Receiver may request the transmitter for probe frames occurring (occurring at dedicated parts of the MAC cycle). The transmitter has to allocate resource (time-slots) to send these probe frames.

The receiver may also request the transmitter to add ACE-symbols (Additional Channel Estimation) in between the header and payload of the frames. Once the receiver has determined a BAT, it provides it to the transmitter. In case of multiple BATs (for the different regions in the MAC cycle), the transmitter chooses the appropriate BAT accordingly. The transmitter indicates the BAT with the BAT-ID in the header of each frame.

The channel estimation for example has a duration of around 1 second.

The establishment of a fresh LiFi channel, up to the point of channel communication, may take 10-20 seconds. If a channel is reconnecting after a lost connection, known software refinements exist which allow the time to be reduced to below 10 seconds, for example 2-3 seconds. This approach may also be applied to the handover from one AP to another.

The prediction of the invention is used to reduce or eliminate this typical 2-3 second disruption, by preparing handover (i.e. registration and estimation as outlined above) in advance while the existing communication link is still active.

The information to be handed from the old AP to a potential new AP during such a handover for example includes the MAC address of the ED in question. It may furthermore provide the IP address as assigned and any security information like keys for encrypted systems and used physical layer parameters such as assigned bands and bit loading.

The AP can also transfer any information about an available RF connection to the same ED, such as a MAC/IP address for a parallel channel via WiFi or any Bluetooth connection. The receiving unit may also occasionally search for other AP signals (independently of the trajectory prediction).

FIG. 4 shows an Optical Wireless Communication, OWC, method for transferring data between a transmitting unit, which is one transmitting unit of a set of transmitting units, and a receiving unit.

In step 60, data is transmitted from the transmitting unit to the receiving unit.

In step 62, motion and orientation of the receiving unit is sensed.

In step 64, a prediction of the future orientation and movement of the receiving unit is derived, while receiving data from the transmitting unit. Depending on the prediction, a different transmitting unit of the set may be identified in step 66 or else it is determined in step 68 that a different communication system should be used for future data transfer.

As discussed above, embodiments make use of multiple controllers. Each controller can be implemented in numerous ways, with software and/or hardware, to perform the various functions required. A processor is one example of a controller which employs one or more microprocessors that may be programmed using software (e.g., microcode) to perform the required functions. A controller may however be implemented with or without employing a processor, and also may be implemented as a combination of dedicated hardware to perform some functions and a processor (e.g., one or more programmed microprocessors and associated circuitry) to perform other functions.

Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media such as volatile and non-volatile computer memory such as RAM, PROM, EPROM, and EEPROM. The storage media may be encoded with one or more programs that, when executed on one or more processors and/or controllers, perform the required functions. Various storage media may be fixed within a processor or controller or may be transportable, such that the one or more programs stored thereon can be loaded into a processor or controller.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”.

Any reference signs in the claims should not be construed as limiting the scope.

1. A Optical Wireless Communication (OWC) receiving unit for an OWC system for transferring data between a transmitting unit, which is one transmitting unit of a set of ceiling-mounted transmitting units and the receiving unit as an optical signal which is propagated over free space,
the receiving unit comprising:
a motion sensor for sensing motion of the receiving unit and orientation resulting from rotation of the receiving unit;
a light detector arranged to detect received light;
a demodulating system for demodulating the modulated data from the received light;
a local RF transceiver and
a controller which is configured to:
derive a prediction of the future orientation and position of the receiving unit, while receiving data from a transmitting unit of the set and determine from the prediction that:
a different transmitting unit of the set should be used for future data transfer when the receiving unit is in line of sight of one of the different transmitting unit of the set and provide a first instruction for said different transmitting unit of the set to prepare for communication while the communication link with the transmitting unit is still active; and
the local RF transceiver should be used for future data transfer when the receiving unit is not in line of sight of any of the transmitting units of the set and provide a second instruction for a remote RF system to prepare for RF communication while the communication link with the transmitting unit is still active.

2. The OWC receiving unit of claim 1, wherein the motion sensor comprises a linear acceleration sensor and a turn rate sensor.

3. The OWC receiving unit of claim 2, wherein the motion sensor comprises a 3-axis accelerometer and a 3-axis gyroscope.

4. The OWC receiving unit of any one of claim 1, further comprising a memory which stores a spatial layout of the set of transmitting units, and wherein the controller is configured to take into account the spatial layout in order to determine which different transmitting unit should be used and/or determine that the different communication system should be used.

5. The OWC receiving unit of claim 1, wherein the rotational speed is used as an indication as regards to the transmitting unit that will come in line of sight.

6. The OWC receiving unit of claim 1, wherein the controller when communicating using the RF transceiver, switches back to operating using the plurality of OWC transmitting units after the sensed orientation has changed and when the sensed orientation and movement of the receiving unit correspond to being stationary for a predetermined period.

7. An Optical Wireless Communication (OWC) system for transferring data between a transmitting unit and a receiving unit as an optical signal which is propagated over free space,
wherein the system comprises:
an OWC receiving unit as claimed in claim 1;
a set of ceiling-mounted transmitting units, each comprising a light source and a modulating system for modulating data onto a light output and
a system controller in communication with the set of transmitting units.

8. The system of claim 7, further comprising a memory which stores a spatial layout of the set of transmitting units, and wherein the controller is configured to take into account the spatial layout in order to determine which different transmitting unit should be used and/or determine that the different communication system should be used.

9. An Optical Wireless Communication (OWC) method for a receiving unit for an Optical Wireless Communication, OWC, system for transferring data between a transmitting unit, which is one transmitting unit of a set of ceiling mounted transmitting units, and the receiving unit as an optical signal which is propagated over free space, the OWC system further providing a Radio Frequency (RF) link for communication,
the method comprising:
transmitting data from the transmitting unit to the receiving unit;
sensing motion of the receiving unit and orientation resulting from rotation of the receiving unit of the receiving unit;
deriving a prediction of the future orientation and position of the receiving unit, while receiving data from the transmitting unit, and
determining from the prediction that a different transmitting unit of the set should be used for future data transfer when the receiving unit is in line of sight of the different transmitting unit of the set and providing a first instruction for said different transmitting unit of the set to prepare for communication while the communication link with the transmitting unit is still active; and
determining from the prediction that a Radio Frequency (RF) communication system should be used for future data transfer when the receiving unit is not in line of sight of any of the transmitting units of the set and providing a second instruction for the remote RF system to prepare for RF communication while the communication link with the transmitting unit is still active.

10. The method of claim 9, comprising:
storing a spatial layout of the set of transmitting units, and the method comprises taking into account the spatial layout in order to determine which different transmitting unit should be used and/or determine that the different communication system should be used.

11. A non-transitory computer readable medium comprising instructions which, when is the instructions are run on a computer comprised in an Optical Wireless Communication (OWC) receiving unit, cause the OWC receiving unit to perform the method of claim 9.
